(19) United States
(12) Patent Application Publication
(10) Pub. No.: US 2025/0363443 A1
(43) Pub. Date: Nov. 27, 2025

(54) PACKING STATION MONITORING SYSTEM AND METHOD

(71) Applicant: Smart Gladiator LLC, Duluth, GA (US)

(72) Inventor: Pugazhenthi Sankaralingam, Duluth, GA (US)

(21) Appl. No.: 19/070,018

(22) Filed: Mar. 4, 2025

Related U.S. Application Data
(60) Provisional application No. 63/567,242, filed on Mar. 19, 2024.

(51) Int. Cl. G06Q 10/083; G06K 7/10; G06K 7/14

(52) U.S. Cl. CPC G06Q 10/083; G06K 7/10366; G06K 7/1413

(57) ABSTRACT

A packing station monitoring system may comprise a support arm configured to be mounted above a packing station. A content capture device may be mounted on the support arm. The content capture device may comprise a camera. A computing device may be in communication with the content capture device. The computing device may comprise a processor and a memory storing instructions. The instructions may cause the computing device to receive an identifier associated with a carton to be packed. The identifier may be decoded to retrieve metadata associated with the carton. Content capture may be initiated for a time duration. Content capture may be stopped in response to the time duration elapsing or receipt of a command to end recording. The captured content and metadata may be uploaded to a data store.

### RELATED APPLICATION

Under provisions of 35 U.S.C. § 119(e), the Applicant claims the benefit of U.S. Provisional Application No. 63/567,242 filed on Mar. 19, 2024, which is incorporated herein by reference.

It is intended that each of the referenced applications may be applicable to the concepts and embodiments disclosed herein, even if such concepts and embodiments are disclosed in the referenced applications with different limitations and configurations and described using different examples and terminology.

### FIELD OF DISCLOSURE

The present disclosure generally relates to systems and methods for monitoring and documenting supply chain operations. More specifically, it pertains to a packing station monitoring system that captures and analyzes video and photographic content of packing procedures in warehouse environments.

### BACKGROUND

In some situations, supply chain operations require detailed documentation and quality control measures to ensure proper handling and delivery of goods. For example, warehouses may need to capture evidence of proper packing procedures to comply with retailer routing guides and resolve potential shipping disputes. Thus, the conventional strategy is to rely on manual inspection and documentation methods. This often causes problems because the conventional strategy does not provide consistent, reliable evidence that can be easily retrieved and analyzed. For example, manual documentation may be prone to human error, inconsistency, or loss of records.

Existing photo and video documentation systems have attempted to address some of these issues by providing platforms for capturing and storing visual evidence. However, these systems may still require significant manual effort to capture, organize, and interpret the visual data. The manual analysis of images and videos can be time-consuming and may not always detect subtle issues or anomalies in the supply chain process.

Furthermore, traditional documentation methods may not effectively associate relevant metadata with the captured visual content. This can make it challenging to quickly retrieve specific evidence when needed, such as during a shipping dispute or quality control audit. The lack of automated metadata association may result in incomplete or inaccurate records, potentially leading to difficulties in proving compliance with shipping requirements or identifying the root causes of supply chain issues.

Another challenge in conventional supply chain documentation systems is the inability to provide real-time feedback on potential issues. Without immediate detection and notification of problems, such as missing components or improper packing, issues may go unnoticed until later stages of the supply chain, potentially resulting in delays, additional costs, or customer dissatisfaction.

In addition to the challenges mentioned, supply chain operations may face difficulties in maintaining consistent quality control across multiple locations or shifts. For example, different warehouse workers may have varying levels of experience or attention to detail, leading to inconsistencies in packing procedures or documentation quality. This can result in discrepancies in shipping accuracy and customer satisfaction rates between different facilities or time periods.

Additionally, manual inspection processes may be time-consuming and prone to human error. Workers may overlook subtle defects or fail to notice missing components, particularly when dealing with large volumes of goods or complex assemblies. These oversights could potentially lead to costly disputes or quality control issues further down the supply chain.

Moreover, the conventional strategy of relying on manual inspection and documentation methods may not adequately address the increasing complexity of modern supply chains. As supply chains become more global and involve multiple intermediaries, the need for detailed, verifiable documentation at each stage of the process becomes more critical. However, manual methods may struggle to keep pace with the volume and speed of transactions, potentially leading to bottlenecks or incomplete records.

Another issue that may arise from conventional documentation strategies is the difficulty in conducting thorough audits or investigations when problems occur. Without a centralized, easily searchable database of visual evidence and associated metadata, tracing the root cause of a shipping error or quality issue may require extensive time and resources. This can delay problem resolution and potentially impact customer relationships or regulatory compliance.

Conventional methods may struggle to extract and utilize valuable metadata from supply chain documentation. Important information such as shipment dates, product codes, or quantity counts may need to be manually entered into separate systems, increasing the potential for transcription errors and reducing overall operational efficiency.

Furthermore, the lack of real-time visibility into supply chain operations may hinder proactive decision-making and risk management. Traditional documentation methods may not provide timely insights into emerging issues or trends, making it challenging for managers to implement preventive measures or optimize processes based on current data.

In addition to the challenges mentioned, supply chain operations may face difficulties in scaling documentation and quality control processes as the volume of transactions increases. For example, as businesses expand or experience seasonal fluctuations, the manual inspection and documentation methods may struggle to keep pace with the increased workload. This can potentially lead to backlogs, delays, or a decrease in the thoroughness of quality checks.

In some cases, the sheer volume of documentation generated during supply chain operations may overwhelm traditional storage and retrieval systems. Organizations may struggle to effectively organize and search through large collections of images and videos, making it difficult to track shipment histories or investigate quality issues that may arise over time.

Moreover, the conventional strategy of relying on manual inspection and documentation methods may not adequately address the need for standardization across different locations or partners in a global supply chain. Different facilities or third-party logistics providers may have varying procedures for documenting and verifying shipments, potentially leading to inconsistencies in the quality and completeness of records. This lack of standardization may complicate efforts to track and analyze supply chain performance across the entire network.

Another issue that may arise from traditional documentation approaches is the difficulty in quickly adapting to changes in regulatory requirements or customer specifications. As compliance standards evolve or new shipping guidelines are introduced, manual systems may require significant time and effort to update procedures and retrain personnel. This can potentially result in periods of non-compliance or increased risk of errors during transitions.

Furthermore, the lack of real-time visibility into supply chain operations may hinder the ability to implement continuous improvement initiatives effectively. Without timely and comprehensive data on packing procedures, shipping accuracy, and quality control measures, it may be challenging to identify patterns, trends, or opportunities for optimization. This can potentially limit the organization's ability to enhance efficiency and reduce costs in the long term.

Existing solutions have attempted to address some of these challenges through the use of barcode scanning systems or radio-frequency identification (RFID) technology. However, these approaches may still have limitations in capturing detailed visual evidence of packing procedures or identifying subtle quality issues. Additionally, the implementation of such systems may require significant infrastructure investments and may not be easily adaptable to all types of products or shipping environments.

There is a pressing need for an innovative solution to address the multifaceted challenges in supply chain documentation and quality control. Current manual methods and existing photo/video systems may struggle to keep pace with the increasing complexity, volume, and speed of modern global supply chains. A more advanced approach may be required to provide real-time feedback, maintain consistent quality control across multiple locations, enable thorough audits, and support proactive decision-making. Such a solution may need to offer scalability, standardization, and adaptability to changing regulatory requirements while facilitating continuous improvement initiatives. By addressing these critical needs, an improved system could potentially streamline operations, reduce errors, enhance visibility, and ultimately drive significant cost savings and efficiency gains across the entire supply chain network.

### Brief Overview

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

In some embodiments, a packing station monitoring system may comprise a support arm configured to be mounted above a packing station. A content capture device may be mounted on the support arm. The content capture device may comprise a camera. A computing device may be in communication with the content capture device. The computing device may comprise a processor and a memory storing instructions. When executed by the processor, the instructions may cause the computing device to receive an identifier associated with a carton to be packed. The computing device may decode the identifier to retrieve metadata associated with the carton. The computing device may initiate content capture by the content capture device for a time duration. The computing device may stop content capture by the content capture device in response to at least one of: the time duration elapsing or receipt of a command to end recording. The computing device may upload captured content and the metadata to a data store.

The content capture device may further comprise a code reader configured to read the identifier. The computing device may comprise a tablet computer. The support arm may comprise a light to illuminate an area below the support arm. The system may further comprise an audio device configured to provide audible alerts related to operation of the content capture device.

In other embodiments, a packing station monitoring system may comprise a support arm configured to be mounted proximate to a packing station. A content capture device may be coupled to the support arm. The content capture device may comprise a camera and a code reader. A computing device may be in communication with the content capture device. The computing device may comprise a processor and a memory storing instructions. When executed by the processor, the instructions may cause the computing device to receive, via the code reader, an identifier associated with a carton to be packed. The computing device may decode the identifier to retrieve metadata associated with the carton. The computing device may initiate video capture by the camera for a predetermined time duration. The computing device may analyze the video capture in real-time using an artificial intelligence model to detect packing anomalies. The computing device may generate an alert if a packing anomaly is detected. The computing device may stop video capture in response to at least one of: the time duration elapsing or receipt of a stop command. The computing device may upload the video capture and the metadata to a remote data store.

In still other embodiments, a method for monitoring packing operations at a packing station may comprise mounting a support arm above a packing station. The method may comprise removably coupling a tablet computing device to the support arm. The tablet computing device may comprise a camera. The method may comprise receiving, via the camera, an image of a QR code affixed to a carton to be packed. The method may comprise decoding the QR code to retrieve metadata comprising a carton identifier, a sales order number, and a purchase order number associated with the carton. The method may comprise initiating video capture by the camera for a predetermined time duration of 30-60 seconds. The method may comprise displaying a visual countdown timer on a screen of the tablet computing device indicating remaining video capture time. The method may comprise generating an audible alert when 10 seconds of video capture time remains. The method may comprise stopping video capture upon expiration of the predetermined time duration. The method may comprise assembling a packing record comprising the captured video and the retrieved metadata. The method may comprise initiating upload of the packing record to a cloud-based data store. The method may comprise managing sequential upload of multiple packing records to the cloud-based data store using a queuing process.

In yet other embodiments, a packing station monitoring system may comprise a support arm configured to be mounted above a packing station. A tablet computing device may be removably coupled to the support arm. The tablet computing device may comprise a camera, a processor, and a memory storing instructions. When executed by the processor, the instructions may cause the tablet computing device to receive, via the camera, an image of a QR code affixed to a carton to be packed. The tablet computing device may decode the QR code to retrieve metadata comprising a carton identifier, a sales order number, and a purchase order number associated with the carton. The tablet computing device may initiate video capture by the camera for a predetermined time duration of 30-60 seconds. The tablet computing device may display a visual countdown timer on a screen of the tablet computing device indicating remaining video capture time. The tablet computing device may generate an audible alert when 10 seconds of video capture time remains. The tablet computing device may stop video capture upon expiration of the predetermined time duration. The tablet computing device may assemble a packing record comprising the captured video and the retrieved metadata. The tablet computing device may initiate upload of the packing record to a cloud-based data store. The system may comprise a lockdown application installed on the tablet computing device and configured to restrict access to applications other than a packing monitoring application. The system may comprise a queuing process configured to manage sequential upload of multiple packing records to the cloud-based data store.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2A shows an example embodiment of one portion of the packing station monitoring system;

FIG. 2B shows another example embodiment of one portion of the packing station monitoring system including a standalone QR code reader;

FIG. 3 is a flow chart of a method for providing a packing station monitoring system or platform;

FIG. 4 is a block diagram of a system including a computing device for performing the method of FIG. 3;

FIG. 5 shows an example record stored in a Media Metadata Schema (MMS) format;

FIG. 6A, shows media data in the form of an image;

FIG. 6B shows a lamina associated with the image as created by a user;

FIG. 6C shows the lamina data displayed together with the image; and

FIG. 7 shows an example of a camera viewfinder including an overlay from an object identification system.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S.C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Conventional packing and shipping operations often lack robust documentation of the packing process for individual orders. This can lead to disputes between suppliers and retailers regarding whether routing guides were properly followed, whether products were damaged during packing or shipping, or whether the correct items and quantities were included in an order. Without clear evidence of the packing process, suppliers may be unfairly blamed for errors or damage that occurred after the products left their facility.

The present packing station monitoring system addresses these issues by providing automated capture and storage of video evidence showing the packing of each order, along with associated metadata. The system includes hardware components mounted at a packing station to record the packing process, as well as software for controlling the recording, associating it with order information, and securely storing it for later retrieval if needed.

In one example scenario, a supplier ships products to a retailer for sale in retail stores. The retailer provides a detailed routing guide specifying how products should be packed, including requirements for box sizes, dunnage, paperwork inclusion, and sealing methods. Using the present system, as a worker packs an order at a packing station, a video recording is automatically captured showing the entire packing process. The video and associated order information are securely stored in cloud storage.

If the retailer later claims that products were improperly packed, leading to damage, the supplier can quickly retrieve and review the packing video for that specific order. The supplier may be able to demonstrate that proper packing procedures were followed, potentially avoiding costly chargebacks or disputes. Alternatively, if the video reveals improper packing techniques, the supplier can use this information to retrain employees and improve processes.

In another example scenario, a manufacturer ships sensitive electronic components to multiple customers. Proper antistatic packaging and careful handling are critical. The packing station monitoring system captures video evidence of the specialized packing procedures used for each order. If a customer reports receiving damaged components, the manufacturer can review the packing video to verify that appropriate precautions were taken, potentially avoiding liability for damage that may have occurred during shipping or at the customer site.

The system may also be useful in scenarios involving high-value or regulated products. For example, a pharmaceutical distributor may use the system to document the packing of controlled substances, providing an audit trail to demonstrate regulatory compliance. Similarly, a jewelry wholesaler may record the packing of valuable items as evidence in case of theft or loss claims.

The system may incorporate object detection to address a technical problem in supply chain documentation and quality control processes. Traditional manual inspection and documentation methods may be prone to human error, inconsistency, and inefficiency. By leveraging artificial intelligence for automated object detection, measurement, and anomaly identification, the system may enhance accuracy, speed, and reliability of supply chain documentation.

For example, in a warehouse shipping operation, workers may need to verify that pallets are properly loaded, measure pallet heights, count boxes, and check for any missing or damaged items before shipment. Manually performing these tasks across hundreds of pallets per day may be time-consuming and error-prone. The system may automate much of this process.

While the primary use case focuses on outbound shipping from a supplier or manufacturer, the system may also be adapted for use in other supply chain contexts. For example, it could be used to document receiving operations, showing the condition of inbound shipments as they are unpacked. It could also be employed for quality control inspections, capturing video evidence as items are examined and approved or rejected.

The packing station monitoring system may provide several benefits. The system may create an objective record of packing operations that can be used to verify compliance with procedures and resolve disputes. The automated capture process may require minimal additional effort from packing personnel, allowing them to focus on their primary tasks. Videos and metadata captured by the system may be securely stored and easily retrieved, providing quick access to evidence when needed. The system may integrate with existing order management and/or warehouse management systems to associate videos with specific orders and/or shipments. Captured data may be analyzed to identify process improvement opportunities and monitor employee performance.

By addressing the lack of documentation in packing operations, the present system helps suppliers, manufacturers, and distributors reduce liability, improve customer satisfaction, and optimize their processes. The following sections provide a more detailed description of the components and operation of the packing station monitoring system.

The packing station monitoring system may provide an automated solution for capturing and storing video evidence of packing operations along with associated metadata. This addresses the lack of robust documentation in conventional packing and shipping processes that can lead to disputes between suppliers and retailers.

The system may include hardware components mounted at a packing station to record the packing process, as well as software for controlling the recording, associating it with order information, and securely storing it for later retrieval. As a worker packs an order, video recording may be automatically captured and stored in cloud storage along with relevant order metadata.

As the worker prepares to photograph a pallet using the system, AI object detection may analyze the camera viewfinder in real-time or near-real time. The system may outline detected objects (e.g., pallets and boxes), providing an immediate visual indication to the user of what is being recognized. A pallet height measurement may be calculated and displayed based on detected pallet dimensions. A running count of detected boxes may be shown.

When a photo or video is captured, more detailed AI processing may occur either on-device or in the cloud backend. This may include precise object counting and/or measurement, anomaly detection to identify missing or improperly placed items, and/or optical character recognition (OCR) to extract text from shipping labels or documents in the image.

The system may automatically populate metadata fields based on the AI analysis results. For instance, the detected pallet count, box count, and pallet dimensions may be filled in without manual entry. Any anomalies or quality issues identified may be flagged for review.

The system may be used to document receiving operations and inspections and/or outbound packing operations. The system may capture evidence of proper handling for sensitive items like electronic components or pharmaceuticals. The system may allow identification of improper packing and/or unpacking techniques so employees can be retrained, and processes enhanced. Suppliers or receivers may retrieve and review packing and/or unpacking videos to demonstrate proper procedures were followed, potentially avoiding chargebacks or disputes with retailers or other parties to a transaction. The system may provide audit trails for packing of controlled substances or high-value items.

The packing station monitoring system may be applicable in various scenarios, including (but not limited to) a supplier shipping to retailers (e.g., to verify compliance with routing guides and proper packing methods), a manufacturers shipping sensitive components such as electronics, precisely-tuned mechanical devices, and/or the like (e.g., to demonstrate appropriate precautions were taken during packing); distributors of controlled substances, such as pharmaceutical distributors (e.g., to document packing of controlled substances for regulatory compliance), wholesalers of expensive goods such as jewelry, electronics, and/or the like (e.g., to record packing of valuable items as evidence against theft or loss claims).

While primarily designed for outbound shipping operations, the system may be adapted for other supply chain contexts, such as receiving operations and/or other quality control inspections.

The packing station monitoring system may provide several advantages over conventional packing documentation methods. The system may create an objective record of packing operations that can be used to verify compliance with procedures and resolve disputes. The automated capture process may require minimal additional effort from packing personnel, allowing them to focus on their primary tasks. Videos and metadata captured by the system may be securely stored and easily retrieved, providing quick access to evidence when needed. The system may integrate with existing order management and/or warehouse management systems to associate videos with specific orders and shipments. Captured data may be analyzed to identify process improvement opportunities and monitor employee performance.

In a quality control use case at a manufacturing facility, the system may be configured to detect missing fasteners or components on assembled products. As one specific example, in response to a worker photographing a vehicle hood assembly, the AI may analyze the image in real-time to verify all expected fasteners are present. If any are missing, the system may immediately alert the user and prevent the user from proceeding until the issue is resolved.

The cloud backend may apply additional processing and business rules to the captured data. This may include comparing detected objects and measurements against expected values from order data, generating alerts for any discrepancies, and compiling the information into reports and dashboards for management oversight.

The system may generate reports that summarize packing operations. These reports may include various data points captured during the packing process. The report format may be customizable based on user preferences and/or organizational requirements.

Data points that may be included in the packing operation reports include, but need not be limited to carton identifier(s), timestamps for start and end of packing process, duration of packing for each carton, user/employee information, items packed in each carton, any anomalies or issues detected during packing, photos and/or video clips captured during packing, metadata associated with the packing process, and/or any other details useful for the organization in documenting the packing process.

The reports may be generated on a scheduled basis (e.g., daily, weekly, monthly), or on-demand as requested by authorized users. The system may provide options for exporting reports in various document formats such as PDF, CSV, Excel spreadsheets, and/or the like, to facilitate sharing and further analysis.

Advanced reporting features may include one or more of: interactive dashboards allowing users to drill down into specific data points, customizable report templates to meet specific organizational needs, automated alerts based on predefined thresholds or anomalies detected in the data, integration with other business intelligence tools for more comprehensive analysis, or various other data integration and/or visualization features.

The report generation process may be designed to be scalable, allowing for efficient processing of large volumes of packing data across multiple packing stations or warehouses. The system may also incorporate data security measures to ensure that sensitive information is protected and only accessible to authorized personnel.

By automating these inspection and documentation tasks, the system may significantly reduce the time and labor required while improving accuracy and consistency of shipped product. This may lead to fewer shipping errors, enhanced quality control, and more efficient supply chain operations overall.

The object detection system may provide a solution for automating and enhancing supply chain documentation and quality control processes. The system may leverage artificial intelligence capabilities to detect objects, measure dimensions, identify anomalies, and extract text from images captured during various supply chain operations.

The AI system may comprise a mobile application. This app may provide the camera interface, user interface for content capture and metadata entry, and on-device AI processing capabilities. A cloud backend system that may include an AI processing engine, image/video storage, a metadata database, and APIs for integration with other enterprise systems. The system may include one or more AI models for tasks such as object detection, OCR, and image quality assessment. These may utilize frameworks such as TensorFlow or PyTorch. A reporting and alerting system may be built into the application to provide insights and notify relevant personnel of issues. The application may further include one or more Integration APIs to connect with existing enterprise systems like ERP, WMS, and TMS.

The system may operate in various supply chain environments, including shipping/receiving warehouses, transfer points, delivery destinations, and quality control operations. It may enhance existing processes by providing automated verification, measurement, and documentation capabilities.

By addressing the lack of documentation in packing operations, the present system helps suppliers, manufacturers, and distributors reduce liability, improve customer satisfaction, and optimize their processes. The following sections provide a more detailed description of the components and operation of the packing station monitoring system.

The packing station monitoring system provides several technical advantages over conventional systems.

Automated content capture and metadata association: The system automatically initiates video recording when a carton identifier is scanned, and associates relevant metadata like order numbers with the captured content. This eliminates manual steps and potential for human error compared to manual photo/video capture methods.

Integrated hardware and software solution: By combining a tablet device, camera, QR code scanner, and custom software application in a purpose-built system, it provides a cohesive solution optimized for packing documentation. This integration allows for more seamless operation compared to using separate devices and manual processes.

Structured data storage: The use of a standardized Media Metadata Schema (MMS) for storing captured content and associated metadata enables more efficient organization, retrieval and analysis of packing records compared to unstructured storage of photos/videos.

Queued upload process: The system's queuing mechanism for uploading content to cloud storage allows for more robust handling of network interruptions and large data volumes compared to immediate interactive uploads.

Restricted device functionality: The lockdown application limits the tablet to only run the packing monitoring software, reducing potential for misuse or distraction.

Configurable recording duration: The ability to set predetermined recording durations or use stop triggers allows the system to be optimized for different packing processes and requirements.

Real-time packing verification: The system enables immediate review of packing operations, allowing quick identification and correction of errors.

Secure cloud-based storage and access: Centralized cloud storage with controlled access provides better data security and availability compared to local storage on individual devices or computers.

Audit trail creation: The system automatically generates a detailed record of each packing operation, creating an audit trail that can be used for dispute resolution, process improvement, and compliance verification.

Scalability: The cloud-based architecture allows the system to easily scale to multiple packing stations across different locations.

Integration potential: The structured data capture enables potential integration with other supply chain management systems for more comprehensive operational insights.

Customizable detection models: The AI models may be trained on company-specific objects, processes, and quality standards, allowing the system to be tailored to unique operational needs.

Continuous improvement: As more data is processed, the AI models may be refined and improved over time, potentially leading to ever-increasing accuracy and capabilities.

Quantifiable measurements: The system may provide precise object measurements and counts, enabling more data-driven decision making compared to subjective human estimates.

Audit trail creation: By capturing detailed metadata and AI analysis results along with images, the system may generate a comprehensive audit trail for compliance and dispute resolution purposes.

Remote inspection capabilities: The AI-powered analysis may enable some level of remote quality control and verification, potentially reducing the need for on-site inspections in certain scenarios.

Predictive analytics potential: As the system accumulates data over time, it may enable predictive analytics to forecast potential issues or optimize processes based on historical patterns.

By addressing these technical challenges in packing documentation, the system enables more efficient, accountable, and verifiable packing operations compared to conventional manual or partially automated approaches.

The present disclosure includes many aspects and features. Moreover, while many aspects and features relate to, and are described in, the context of packing station monitoring, embodiments of the present disclosure are not limited to use only in this context.

### I. PLATFORM OVERVIEW

This overview is provided to introduce a selection of concepts in a simplified form that are further described below. This overview is not intended to identify key features or essential features of the claimed subject matter. Nor is this overview intended to be used to limit the claimed subject matter's scope.

The present disclosure may provide a packing station monitoring system. The system may comprise a support arm configured to be mounted above a packing station. A content capture device may be mounted on the support arm. The content capture device may comprise a camera. A computing device may be in communication with the content capture device. The computing device may comprise a processor and a memory storing instructions. When executed by the processor, the instructions may cause the computing device to receive an identifier associated with a carton to be packed. The computing device may decode the identifier to retrieve metadata associated with the carton. The computing device may initiate content capture by the content capture device for a time duration. The computing device may stop content capture by the content capture device in response to at least one of: the time duration elapsing or receipt of a command to end recording. The computing device may upload captured content and the metadata to a data store.

The system may further comprise a support arm configured to be mounted proximate to a packing station. A content capture device may be coupled to the support arm. The content capture device may comprise a camera and a code reader. A computing device may be in communication with the content capture device. The computing device may comprise a processor and a memory storing instructions. When executed by the processor, the instructions may cause the computing device to receive, via the code reader, an identifier associated with a carton to be packed. The computing device may decode the identifier to retrieve metadata associated with the carton. The computing device may initiate video capture by the camera for a predetermined time duration. The computing device may analyze the video capture in real-time using an artificial intelligence model to detect packing anomalies. The computing device may generate an alert if a packing anomaly is detected. The computing device may stop video capture in response to at least one of: the time duration elapsing or receipt of a stop command. The computing device may upload the video capture and the metadata to a remote data store.

A method for monitoring packing operations at a packing station may be provided. The method may comprise mounting a support arm above a packing station. A tablet computing device may be removably coupled to the support arm. The tablet computing device may comprise a camera. The method may comprise receiving, via the camera, an image of a QR code affixed to a carton to be packed. The QR code may be decoded to retrieve metadata comprising a carton identifier, a sales order number, and a purchase order number associated with the carton. Video capture by the camera may be initiated for a predetermined time duration of 30-60 seconds. A visual countdown timer may be displayed on a screen of the tablet computing device indicating remaining video capture time. An audible alert may be generated when 10 seconds of video capture time remains. Video capture may be stopped upon expiration of the predetermined time duration. A packing record may be assembled comprising the captured video and the retrieved metadata. Upload of the packing record to a cloud-based data store may be initiated. Sequential upload of multiple packing records to the cloud-based data store may be managed using a queuing process.

Embodiments of the present disclosure may comprise methods, systems, and a computer readable medium comprising, but not limited to, at least one of the following:
A. A Content Capture Device;
B. A Content Capture Controller;
C. A Communication Device;
D. A Data Store;

In some embodiments, the present disclosure may provide an additional set of modules for further facilitating the software and hardware platform. The additional set of modules may comprise, but not be limited to:
E. A Support Arm;
F. An Audio Device.

Details with regards to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components as found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
mounting a support arm above a packing station;
removably coupling a tablet computing device comprising a camera to the support arm;
receiving, via the camera, an image of a QR code affixed to a carton to be packed;
decoding the QR code to retrieve metadata associated with the carton;
initiating video capture by the camera for a predetermined time duration;
stopping video capture upon expiration of the predetermined time duration;
assembling a packing record comprising the captured video and the retrieved metadata;
initiating upload of the packing record to a cloud-based data store; and
managing sequential upload of multiple packing records to the cloud-based data store using a queuing process.

Although the aforementioned method has been described to be performed by the packing station monitoring platform 100, it should be understood that computing device 400 may be used to perform the various stages of the method. Furthermore, in some embodiments, different operations may be performed by different networked elements in operative communication with computing device 400. For example, a plurality of computing devices may be employed in the performance of some or all of the stages in the aforementioned method. Moreover, a plurality of computing devices may be configured much like a single computing device 400. Similarly, an apparatus may be employed in the performance of some or all stages in the method. The apparatus may also be configured much like computing device 400.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. PLATFORM CONFIGURATION

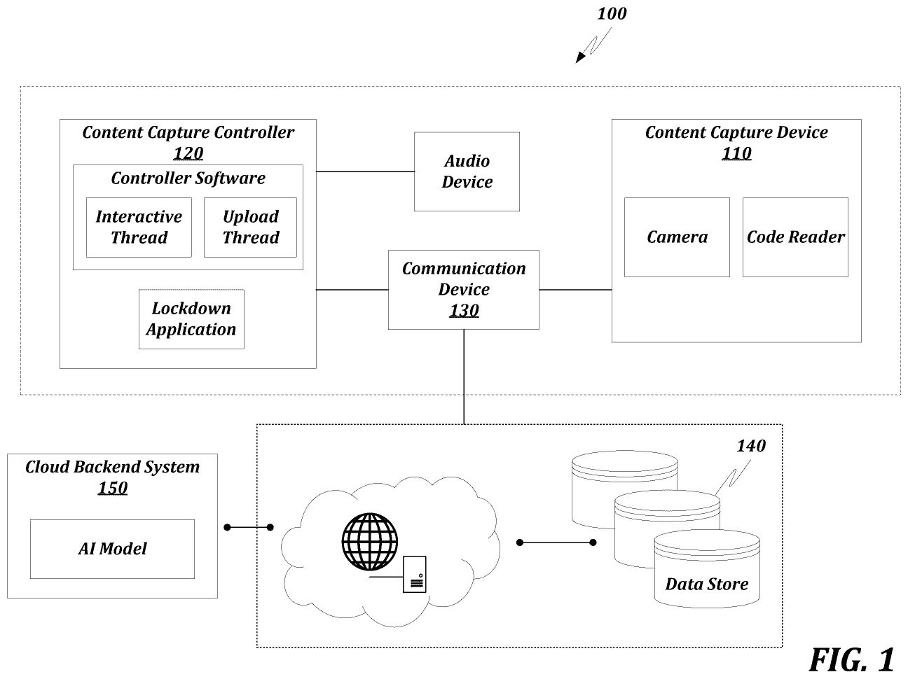

FIG. 1 illustrates one possible operating environment through which a platform consistent with embodiments of the present disclosure may be provided. By way of non-limiting example, a packing station monitoring system or platform 100 may be hosted on, for example, a cloud computing service. In some embodiments, the platform 100 may be hosted on a computing device 400. A user may access platform 100 through a software application and/or hardware device. The software application may be embodied as, for example, but not be limited to, a website, a web application, a desktop application, and a mobile application compatible with the computing device 400.

The packing station monitoring system may be implemented in a warehouse, distribution center, fulfillment center, or other facility where products are packed for shipment. The system is designed to operate at individual packing stations where workers pack products into boxes or cartons for shipping to customers or retailers.

As shown in FIG. 1, the packing station monitoring platform 100 includes a content capture device 110 mounted on a support arm above a packing station. The content capture device 110 may include a camera for capturing video and/or still images of the packing process. The content capture device 110 may also include a code reader, such as a barcode scanner or QR code reader, for reading identifiers on cartons or packing slips.

A content capture controller 120 is in communication with the content capture device 110. The content capture controller 120 may be a computing device such as a tablet computer or other mobile device running software for controlling the content capture device 110. In some embodiments, the content capture controller 120 and content capture device 110 may be integrated into a single device, such as a smartphone or tablet with built-in camera and scanning capabilities.

The platform 100 also includes a communication device 130 for transmitting captured content and associated metadata to a remote data store 140. The communication device 130 may utilize cellular networks, Wi-Fi, or other wireless communication protocols to transmit data. The data store 140 may be a cloud-based storage system accessible over the internet.

An audio device 150 may also be included in the operating environment to provide audible alerts or instructions to the packing station worker. The audio device 150 may be integrated with the content capture controller 120 or may be a separate speaker system.

The packing station itself typically includes a work surface where cartons can be placed for packing. Shelving or bins containing products to be packed may be positioned within reach of the packing station. A computer terminal or tablet device for accessing order information may also be present at the packing station.

The packing station monitoring platform 100 is designed to integrate with existing warehouse management systems and order fulfillment processes. The packing station monitoring system captures visual evidence of the packing process without significantly disrupting or slowing down normal packing operations.

In some alternative embodiments, the content capture device of the packing station monitoring platform 100 may include multiple cameras positioned at different angles to capture comprehensive views of the packing process. For example, overhead, side, and front-facing cameras could be used. The support arm may be motorized to allow automated adjustment of camera angles and positions. The platform 100 may optionally incorporate depth sensing cameras or 3D scanners to capture volumetric data about items being packed and carton fullness. The system may use lidar technology for precise 3D mapping of packed cartons. Biometric authentication (e.g., fingerprint, facial recognition, etc.) may be used to identify packers and associate them with specific packing sessions.

The system may optionally incorporate RFID or NFC readers to automatically detect and log tagged items as they are packed. In some embodiments, the system may include weight sensors integrated with the packing station to verify that the packed weight matches expected weight based on the order details. In some embodiments, machine learning algorithms may be used (e.g., to analyze the captured video in real-time and detect packing errors or deviations from standard procedures). The system may optionally be integrated with smart packaging materials that can detect and report on package integrity during shipping.

Augmented reality displays may optionally be incorporated to provide visual guidance to packers about item placement and packing instructions. In some embodiments, voice control and/or natural language processing may allow for hands-free operation of the system by packers.

Thermal imaging cameras could be used to detect heat signatures of items being packed, which may be useful for certain types of products (e.g., products that may be required to be cold-packed or hot-packed). Hyperspectral imaging may optionally be used to detect material properties of packed items. One or more gas sensors may be Incorporated to detect volatile organic compounds or other emissions from packed items. Environmental sensors may be used to monitor temperature, humidity, etc. associated with the ambient (warehouse) environment during packing. The platform 100 may optionally incorporate one or more high-speed cameras to capture slow motion video of item packing, which may be useful for fragile items.

The system may be integrated with robotic packing systems to capture and verify automated packing processes. Integration with autonomous mobile robots may allow for transport packed of cartons away from packing stations.

The content capture controller may be implemented as a cloud-based service rather than a local device, allowing centralized management across multiple packing stations. The system may use blockchain technology to create an immutable record of packing operations.

Accordingly, embodiments of the present disclosure provide a software and hardware platform comprised of a distributed set of computing elements, including, but not limited to:

### A. A Content Capture Device

In some embodiments, the packing station monitoring system or platform 100 may include a content capture device 110. The content capture device may include hardware and/or software configured to record or otherwise capture photo and/or video content. In embodiments, the content capture device may have a resolution sufficient to clearly capture the packing of a box or carton within a field of view of the content capture device. For example, the resolution may be on the order of 1 megapixel, 3 megapixels, 10 megapixels, or any other resolution. Those of skill in the art will recognize that different resolutions may be useful depending on factors such as, but not limited to, the product to be packed in the cartons, the distance between the content capturing device and the carton, and/or the desired level of detail in the image.

In some embodiments, the camera of the content capture device may be configured to read an identifier, such as a QR code, a barcode, or a text-based label affixed to or otherwise displayed on a carton or box. Additionally or alternatively, the content capture device may include a separate reader device configured to read the identifier, such as a QR code reader, barcode reader, scanner, etc. In embodiments the QR code reader may be capable of reading a high volume of QR codes daily. For example, the QR code reader may be capable of reading 220 or more QR codes daily without overheating or failing.

The code reader may comprise an optical sensor and image processing software configured to detect and decode various types of machine-readable codes such as barcodes, QR codes, and data matrix codes. The code reader may be integrated with the camera hardware of the content capture device 110 to utilize the camera's optical components and image sensor.

When capturing an image or video, the code reader software may analyze each frame in real-time to detect the presence of any supported code types. Common code detection techniques may include edge detection, pattern recognition, and image segmentation algorithms optimized for machine-readable codes. Supported code types may include, but need not be limited to 1D barcodes (e.g., UPC, EAN, Code 39, Code 128, etc.), 2D codes (e.g., QR codes, Data Matrix, PDF417, etc.), and/or Postal codes (e.g., POSTNET, IMB, etc.).

Once a code is detected, the reader may employ specialized decoding algorithms to extract the encoded information. For QR codes, this may involve analyzing the finder patterns, alignment patterns, and data cells to reconstruct the original data. For 1D barcodes, it may involve measuring and decoding the widths of bars and spaces.

The decoded information may then be passed to the content capture controller 120 for further processing. The controller software may use this information to retrieve associated metadata for the scanned item from a database, and populate data fields in the packing record automatically. The system may trigger specific packing workflows based on the item type. In some embodiments, the system may validate that the correct item(s) are being packed.

By integrating the code reader directly with the camera, the system may enable seamless scanning of codes during the normal packing and documentation process without requiring separate scanning hardware. This may improve efficiency and reduce errors in data entry and item identification during packing operations.

### B. A Content Capture Controller

In some embodiments, the packing station monitoring system or platform 100 may include a content capture controller 120. In embodiments, the content capture controller may include a computing device 400.

The content capture controller may include hardware and/or software configured to control the content capture device. In some embodiments, the content capture controller and the content capture device may be embodied as a single monolithic device. For example, the content capture controller and the content capture device may be formed as a tablet computer, smartphone, personal digital assistant, or laptop computing device. In other embodiments, the content capture controller and the content capture device may be separate devices. As one non-limiting example, the content capture controller may be a computing device, and the content capture device may be a digital camera device.

The content capture controller may be in signal communication with the content capture device. In some embodiments, the content capture controller can communicate with the content capture device via signals transmitted over wires or communication buses that connect the content capture controller to the content capture device. Additionally or alternatively, the content capture controller and the content capture device may communicate wirelessly, using a personal area network (e.g., a Bluetooth network), a local area network (e.g., a wi-fi network), a mesh network, a radio frequency network, a cellular network, or any other means of wireless communication.

The content capture controller may include content capture controller software that, when executed, causes the content capture controller to control operation of the content capture device. A user may initialize the software by tapping or otherwise selecting an icon associated with the content capture controller software. In some embodiments, a user may be required to enter an identifier and/or a password to begin operation of the software.

The software may perform operations that cause the content capture device to begin and/or end content capture, and/or specify a type of content to be captured. For example, the software may cause the content capture controller to transmit, to the content capture device, instructions to begin and/or end content capture. In some embodiments, the content capture controller may send instructions to the content capture device which cause content to be captured for a fixed time period (e.g., 30 seconds, 60 second, 2 minutes, etc.) The duration of the time period may be selected by a user.

In embodiment, the content capture device may receive at least a portion of the captured content from the content capture device. The content capture device may be configured to analyze the received content. For example, the content capture controller may analyze the content to locate an identifier within the content. The identifier may include a QR code, a barcode, a text-based label, or other identifier associated with a carton or box. In embodiments, processing the identifier may include, for example, decoding a QR code, reading a barcode, or performing an optical character recognition process on a text-based label. The processing may include retrieving information directly from (or based directly on) the identifier, or may include determining, based on the identifier, a uniform resource indicator (URI) from which the information may be retrieved. The information determined based on the identifier may include, but need not be limited to, a carton identifier associated with a particular carton, a sales order identifier associated with a particular sales order to which the carton is assigned, and/or a purchase order identifier associated with a purchase or to which the carton belongs.

Optionally, the content capture controller may include a lockdown application including hardware and/or software configured to limit or prevent access to one or more other applications, and/pr to one or more websites. The lockdown application used to restrict access to other applications on the device may be installed as a system-level application with elevated privileges on the device. This may allow it to control access to other applications. When activated, the lockdown application may utilize a Device Administration APIs to enforce restrictions on the device. This may include disabling certain system settings and preventing installation and/or uninstallation of apps. The lockdown application may implement an app whitelist, specifying which applications are allowed to run. All other applications may be blocked from launching. Additionally or alternatively, it may intercept app launch intents using a custom launcher or by registering as the default launcher. This may allow it to control which apps can be opened.

The lockdown application may utilize one or more APIs to monitor app usage information and terminate any unauthorized applications that are launched. It may implement a custom home screen that only displays allowed applications. The default home button behavior may be overridden to always return to this custom home screen. The lockdown application may disable or hide one or more system UI elements to prevent access to other applications. The application may implement a secure unlock mechanism, such as a password or biometric authentication, to allow administrators to exit lockdown mode. The lockdown state and allowed applications list may be managed remotely through a mobile device management (MDM) solution integrated with the lockdown application. Logs of lockdown activity, including any attempts to access restricted applications, may be maintained and uploaded to a central server for auditing purposes.

### C. A Communication Device

In some embodiments, the packing station monitoring system or platform 100 may include a communication device 130. The communication device may include hardware and/or software configured to facilitate communication between the content capture device, the content capture controller, and the data store. In some embodiments, the communication device, the content capture controller and/or the content capture device may be embodied as a single monolithic device. For example, the communication device, the content capture controller, and the content capture device may be formed as a tablet computer, smartphone, personal digital assistant, or laptop computing device. In other embodiments, the communication device may be formed as a standalone device in signal communication with the content capture controller and the content capture device. As one non-limiting example, the content capture controller may be a computing device, and the content capture device may be a digital camera device.

The communication device may facilitate communication using, byway of non-limiting example, one or more wired communication buses, one or more personal area networks, one or more local area networks, one or more cellular (e.g., 3G, LTE, 5G, etc.) networks, one or more radio frequency networks, one or more mesh networks, or any other wired or wireless means of communicating between devices.

### D. A Data Store

In some embodiments, the packing station monitoring system or platform 100 may include a data store, and/or may communicate with a third-party data store. The data store 140 may be located remotely relative to the content capture controller (e.g., in another room, another building, another region, etc.) or may be substantially collocated with the content capture controller. The data store may include hardware and/or software configured to store content and associated metadata received from one or more content capture controllers. In some embodiments, the data store may include a database configured to store the received content data and associated metadata.

In an embodiment, the content capture controller is configured to transmit data to the data store. In an embodiment, the content capture controller is configured to transmit data to the data store by ‘pushing’ the data via an application programming interface (API) of the data store. For example, data may be pushed using user credentials that a user has provided for that particular data store. Alternatively or additionally, a data store may be configured to ‘pull’ data from the content capture controller via an API of the content capture controller, using an access key, password, and/or other kind of credential that a user has supplied to the data store. The data store may be configured to receive data from the content capture controller in many different ways.

In some embodiments, the data store 140 may be hosted on a cloud server. The captured content and associated metadata may be stored in a distributed cloud storage system. This system may utilize object storage services such as (but not limited to) Amazon S3 or Google Cloud Storage to provide scalable and durable storage for large volumes of image and video files. The metadata may be stored in a separate database system, such as a NoSQL database like MongoDB or Cassandra, to allow for flexible schema and efficient querying.

Content retrieval may be facilitated through a content delivery network (CDN) to enable fast access from various geographic locations. The system may implement caching mechanisms at multiple levels to improve retrieval performance for frequently accessed content. An API layer may be provided to allow authorized applications and users to query and retrieve content based on various parameters such as date, user, carton identifier, or custom metadata fields.

The cloud infrastructure may be designed to automatically scale based on demand. This may include using auto-scaling groups for compute resources and implementing sharding or partitioning strategies for the database layer. Load balancers may be employed to distribute incoming requests across multiple server instances. The system may utilize serverless computing technologies, such as AWS Lambda or Google Cloud Functions, for certain processing tasks to improve scalability and cost-efficiency.

Access to the stored content and metadata may be controlled through a multi-layered security approach. This may include strong user authentication mechanisms, such as multi-factor authentication and single sign-on (SSO) integration, role-based access control (RBAC) to define granular permissions for different user types and operations, encryption at rest for stored data and encryption in transit for all network communications using protocols such as TLS/SSL, maintaining detailed audit logs of all access attempts and operations performed on the stored content, implementing virtual private cloud (VPC) configurations, firewalls, and/or intrusion detection/prevention systems to secure the cloud infrastructure, utilizing API keys, OAuth tokens, or JSON Web Tokens (JWT) for secure API access, implementing multi-tenancy with strict data isolation between different customers or organizational units, and/or any other security measures.

The cloud infrastructure may also incorporate regular security audits, vulnerability assessments, and compliance checks to ensure ongoing protection of the stored content and associated metadata.

### E. A Support Arm

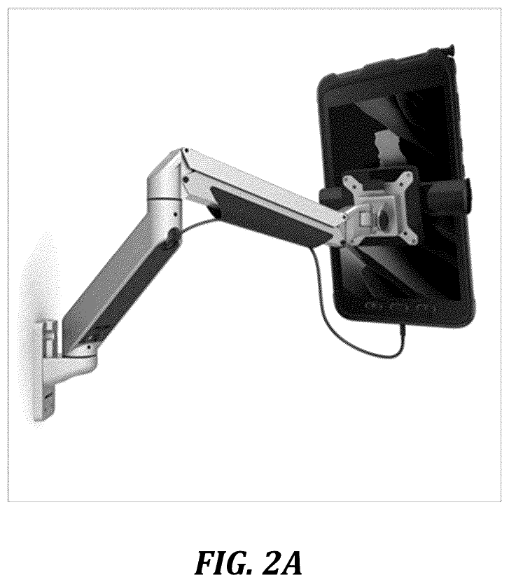

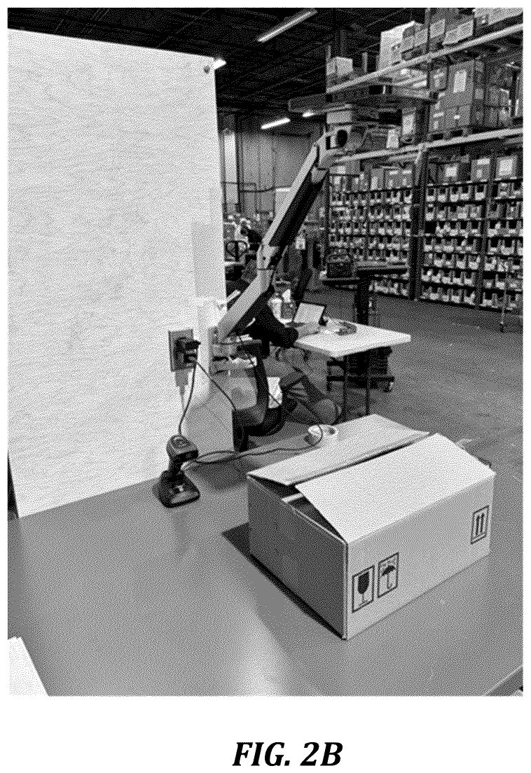

In some embodiments (e.g., where the camera device is to be mounted on a stationary object, such as a packing station), the packing station monitoring system or platform 100 may optionally include a support arm. As shown in FIGS. 2A and 2B, the support arm may support one or more of the content capture device, the content capture controller, and the communication device. The support arm may have a first end attached to a building structure or packing station, and a second end extending outward over a packing area of the packing station. In some embodiments, the support arm may be fixed and immovable relative to the structure to which it is attached. In other embodiments, the support arm may be extendable, rotatable, and/or otherwise movable relative to the structure.

In some embodiments, the support arm may optionally include a light, such as an LED, fluorescent, halogen, and/or incandescent light providing illumination to the area below the support arm, this light may aid in capture of content.

The support arm may be constructed of durable materials such as aluminum or stainless steel to withstand industrial environments. The arm may have a length of approximately 12-24 inches to provide adequate reach and positioning flexibility. A ball joint or multi-axis hinge mechanism may be incorporated at the base and device mounting end to allow for a wide range of motion and positioning options.

The device mounting end may feature an adjustable clamp or cradle designed to securely hold tablets or smartphones of various sizes, typically accommodating devices with screen sizes from 7-12 inches. This mounting interface may utilize spring-loaded grips or adjustable brackets to firmly grasp the device while allowing for easy insertion and removal.

A locking knob or lever may be included to tighten the arm's joints and fix it in the desired position once adjusted. This may prevent unwanted movement during use. The arm may also incorporate internal cable routing channels to neatly manage power and data cables for the mounted device.

At the base, the support arm may attach to surfaces via a heavy-duty clamp mechanism suitable for table edges or a wall-mount plate with pre-drilled holes for permanent installation. The base attachment may feature a quick-release mechanism to allow for easy relocation of the entire arm assembly if needed.

The materials and construction of the support arm may be designed to meet relevant safety and durability standards for industrial equipment. Anti-corrosion coatings or treatments may be applied to protect the arm in harsh warehouse environments.

### F. An Audio Device

In some embodiments, the packing station monitoring system or platform 100 may optionally include an audio device. The audio device may include a speaker, a buzzer, a piezoelectric transducer, and/or any other device capable of emitting a sound. The audio device may be used to provide alerts related to the functioning of the content capture device and/or the content capture controller. As a particular example, the audio device may produce an audible alert when content capture begins and/or ends. In some embodiments, the audio device may emit an alert periodically (e.g., every 10 seconds) during content capture. This may serve as a reminder that content capture is active, and/or may help a packer to gauge whether or not they are on track to complete packing of a carton within the allotted time.

### III. MEDIA METADATA SCHEMA

In some embodiments, the content capture controller 120 may transmit structured data to the data store 140. The data may be transmitted in the form of a data structure, such as a Media Metadata Schema (MMS) record 500. In embodiments, the Media Metadata Schema record 500 is a dataset that accurately defines one or more (e.g., each) of the following:
a thorough background of context (e.g., outbound shipping, inbound receiving, Gemba walk, etc.),
a thorough background of the use case (e.g., a purchase order number, sales order number, and/or bill of lading number),
accurate information on what DATE the data was captured,
accurate information on what TIME the data was captured,
accurate information on which USER captured the data,
accurate information on at what LOCATION the data was captured,
accurate information on what DEVICE HARDWARE was used to capture the data, and/or
accurate information on what OPERATING SYSTEM was used to capture the data.

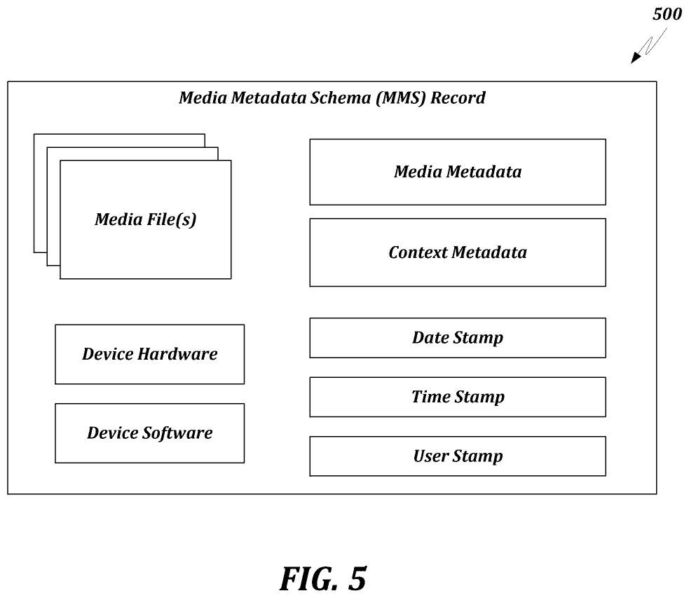

In some embodiments, as illustrated in FIG. 5, the MMS record 500 may include, but need not be limited to, one or more media files, metadata defining the context of the one or more media files, metadata defining the context and/or use case associated with the media files, a date stamp, a time stamp, a user stamp, geolocation data, hardware data, software data, and/or any other data useful in storing and contextualizing content captured for documenting the actions performed by the user.

The one or more media files may include, for example, one or more photos, one or more videos, one or more documents, and/or any other media file useful in documenting a process performed by a user. In some embodiments, one or more media files may include a lamina, which allows a user to highlight one or more portions of the media file and/or add notes associated with the media file. The lamina enables a user to add remarks or comments to a media file without editing the media file directly, so that the original media file is still locked and the original record is preserved without any edits. In this way, a user may retain the exact photo proof that was captured during the user's processing. The media files may form documentation that provides compelling, concrete, court-ready proof so the users can completely trust the proof that is shared from this system, while also allowing the users to add comments or draw remarks on the media files so that they can add more information or add context to the media files.

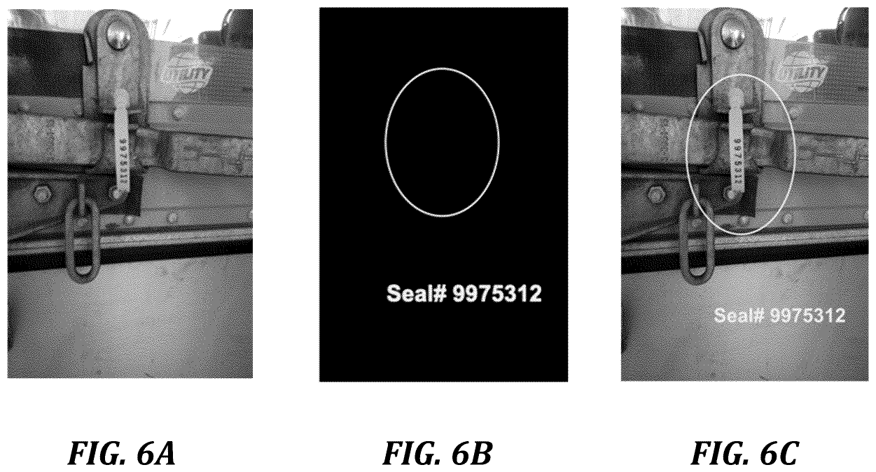

The lamina may allow users to add remarks and/or comments, and/or circle or otherwise highlight areas that need to be closely inspected within the media during the capture of the photos. The lamina may be stored as a separate component in the database. The lamina may be displayed together with the media file, or the media file may be viewable separately, without the lamina. The lamina may be available for all the media file types, including photos, videos, documents, and/or any other media file types. As an example, FIG. 6A, shows media data in the form of an image, FIG. 6B shows a lamina associated with the image as created by a user, and FIG. 6C shows the lamina data displayed together with the image.

The metadata stored in the MMS record 500 may include, for example, metadata related to the context for the one or more captured media files and/or metadata related to the context of the process performed by the user in capturing the media files. The metadata related to the context of the one or more media files may include, for example, a purchase order number, a sales order number, a bill of lading number, a carrier identifier (e.g., a Standard Carrier Alphabet Code), a customer identifier, a serial number, and/or any other data associated with the order associated with the user's process. The metadata related to the context of the process performed by the user in capturing the media files may include an indicator of the process being performed by the user, including inbound receiving, outbound shipping, quality audit, Gemba walk, and/or any other process being performed.

The MMS record 500 may include one or more date stamps that indicate one or more dates associated with capture of the media files and/or transmission of the one or more media files to the data store 140. The one or more date stamps may be formatted in any way useful for recording the data information.

The MMS record 500 may include one or more time stamps that indicate one or more times associated with capture of the media files and/or transmission of the one or more media files to the data store 140. The one or more time stamps may be formatted in any way useful for recording the time information.

The MMS record 500 may include a user stamp associated with a user that performed the process. For example, the user stamp may include a user identifier, user name, biometric data associated with the user, and/or and other user data used for authenticating a user that performed the process.

The MMS record 500 may include geolocation data indicating location(s) where the one or more media files were captured. The geolocation data may include, for example, global positioning system (GPS) coordinates, latitude and longitude measures, city and state identifiers, and/or any other location identifiers associated with a location of the device used to capture the media file.

The MMS record 500 may include hardware information associated with a device that captured the one or more media files. In embodiments, the hardware information may include a device type, a device model number, a device serial number, and/or any other identifier associated with the device.

The MMS record 500 may include software information associated with software operating on a device that captured the one or more media files. In embodiments, the software information may include an operating system identifier, an application identifier, and/or any other identifier associated with the software operating on the device.

### IV. OBJECT DETECTION SYSTEM

The object detection system may comprise a mobile application running on a mobile computing device such as a smartphone or tablet computer. The mobile application may include a camera interface that allows a user to capture photos and/or videos of objects in a supply chain environment.

The camera interface may incorporate real-time or near-time object detection capabilities. As the user points the camera at an object, the system may analyze the live camera feed to detect and outline relevant objects such as pallets, boxes, or specific components. This real-time feedback may be displayed as an overlay on the camera viewfinder.

For example, when inspecting a vehicle hood assembly, the system may outline the hood and highlight expected fastener locations. The AI model may be trained to recognize the specific fastener pattern for that hood model. If any fasteners are missing, the system may flag those locations in real-time on the viewfinder display.

The mobile application may allow the user to capture a photo and/or video once the desired objects are in frame. Upon capture, the image or video may be processed locally on the device. This local processing may include object detection, anomaly checking, and optical character recognition (OCR) on any visible text.

Additionally or alternatively, the captured photo and/or video and associated metadata may be uploaded to a cloud backend system 150 over a wired and/or wireless network connection. The cloud system 150 may perform more intensive AI processing on the uploaded data, including (but not limited to) advanced object detection, precise measurements, comprehensive anomaly detection, and full OCR.

The artificial intelligence (AI) model for performing real-time video analysis to detect packing anomalies may be implemented using a convolutional neural network (CNN) architecture optimized for object detection and classification tasks.

The CNN may be trained on a large dataset of packing images and videos to recognize common packing elements such as boxes, packing materials, products, labels, and packing tools. The model may be fine-tuned to detect specific anomalies like missing items, incorrect items, improper packing techniques, or inadequate protective packaging.

To achieve real-time or near real-time performance, the video stream from the content capture device may be preprocessed to reduce resolution and frame rate before being fed into the AI model. The AI model may analyze frames at regular intervals rather than processing every frame.

The system may utilize hardware acceleration such as GPUs or specialized AI chips to speed up inference. Model quantization and pruning techniques may be applied to reduce model size and computational requirements while maintaining accuracy.

The AI processing pipeline may include steps for video frame preprocessing and resizing and frame batching for efficient processing. A CNN forward pass may generate object detections and classifications. Post-processing of model outputs may be used to identify anomalies, and anomalies may be tracked across multiple frames. The system may generate alerts for detected anomalies.

The system may employ parallel processing to handle multiple video streams simultaneously. Load balancing and distributed computing techniques may be used to scale processing across multiple devices or servers as needed.

The AI model and processing pipeline may be optimized for the specific hardware of the content capture device and computing device. Model architecture, hyperparameters, and processing methods may be tuned to balance accuracy, latency, and resource utilization.

The system may implement adaptive processing, dynamically adjusting model complexity and frame processing rate based on available computational resources and detected activity levels in the video stream.

Detected anomalies may be highlighted in the video feed displayed to the user. The system may provide real-time feedback by overlaying bounding boxes, labels, and alerts on the video stream. Audio alerts may also be generated to notify users of detected issues.

The AI model may be periodically updated and retrained as new data becomes available. The system may implement online learning to continuously improve detection accuracy based on user feedback and corrections.

By leveraging these AI techniques and optimizations, the system may achieve real-time packing anomaly detection to enhance quality control and efficiency in packing operations.

The AI model may output an anomaly score or classification, which can be thresholded to trigger alerts. Explainable AI techniques may be incorporated to highlight detected anomalies visually. The system may also include a feedback loop to incorporate human expert input for continuous improvement.

The cloud backend 150 may apply one or more business rules to the AI analysis results. For example, the backend 150 may flag any missing components or measurements outside of expected ranges. The system 150 may generate alerts for any detected issues, which could be sent to relevant personnel (e.g., via email and/or SMS).

After cloud processing is complete, the results may be returned to the mobile device for display to the user. The mobile application may present an annotated version of the captured image highlighting detected objects, measurements, and any detected anomalies. In some embodiments, the user may be given the opportunity to review and add or edit metadata before submitting the final data package.

The system may integrate with existing enterprise software systems such as ERP, WMS, and/or quality management platforms. This integration may allow the object detection system to retrieve relevant order data and/or specifications to compare against the AI analysis results. In some embodiments, the integration may enable detected issues to be automatically logged in appropriate tracking systems.

The physical environment where inspections occur may be configured to optimize AI-based detection. This could include providing proper lighting conditions, adding visual markers or reference objects to assist with object detection and measurement, and/or the like. The system may be capable of operating in various supply chain environments including warehouses, manufacturing facilities, and delivery locations.

In some embodiments, the object detection system running on the cloud backend 150 may include various AI frameworks for object detection and analysis. While TensorFlow or PyTorch may be used in one embodiment, alternative frameworks such as Caffe, MXNet, or Keras may be employed in other implementations.

On-device AI processing capabilities may vary between implementations. Some embodiments may rely entirely on cloud-based processing, while others may perform more extensive AI analysis directly on the mobile device.

The system may incorporate additional sensors beyond the camera to enhance object detection and measurement capabilities. This may include, as non-limiting examples, depth sensors, infrared cameras, LIDAR technology, and/or the like.

The anomaly detection capabilities may be customized for different industries or use cases. Specialized models may be developed for automotive parts inspection, pharmaceutical quality control, food safety applications, etc.

The reporting and alerting system may be expanded to include different communication channels. In addition to email and SMS notifications, the system may integrate with enterprise messaging platforms and/or generate automated voice calls for critical issues.

Some embodiments may incorporate machine learning techniques to continuously improve object detection accuracy based on user feedback and corrections.

Enhanced data analytics capabilities may be incorporated, allowing for trend analysis, predictive maintenance, or supply chain optimization based on the aggregated inspection data.

The system may be integrated with blockchain technology to provide an immutable record of inspections and detected anomalies for applications requiring a high level of traceability and accountability.

With reference to FIG. 1, the operating environment for enabling the embodiments of the present disclosure may comprise a mobile computing device (e.g., the content capture device 110) with a camera positioned to capture images of an object or assembly being inspected.

The mobile device may execute a mobile application that may interface with the device camera to provide a live camera viewfinder interface to a user. As the user prepares to capture an image, the application may continuously analyze the camera viewfinder feed in real-time using on-device artificial intelligence processing capabilities.

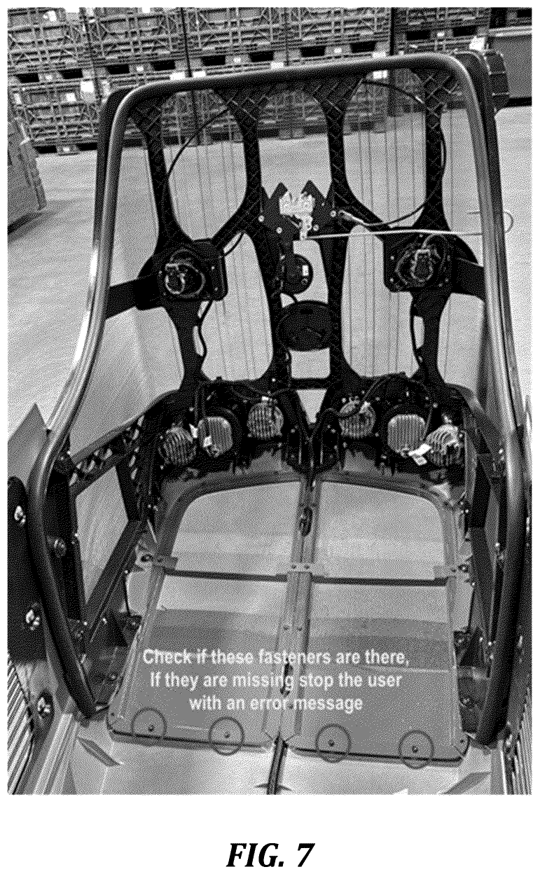

AI processing (e.g., processing performed on the mobile device) may detect and outline relevant objects visible in the camera viewfinder, such as the metal frame structure depicted in FIG. 7. The AI may be configured to identify specific components or features of interest, such as the circular fastener locations indicated by red circles in FIG. 7.

The mobile application user interface may overlay visual indicators on the camera viewfinder to guide the user. For example, yellow text instructions may be displayed, as shown in FIG. 7 stating “Check if these fasteners are there”. If the fasteners are missing, the mobile application may stop the user with an error message. While FIG. 7 shows one specific example of a visual overlay for a camera viewfinder, those of skill in the art will recognize that various other overlays highlighting visual features within the viewfinder and/or providing user instructions are possible.

The operating environment may further comprise a cloud backend system 150 that may receive captured images and metadata from the mobile device over a wireless network connection. The cloud backend 150 may perform additional AI processing on received images to detect anomalies or missing components. While depicted as a separate element in FIG. 1, in some embodiments, the cloud backend 150 may be integrated with the data store 140.

An enterprise network infrastructure may enable communication between the mobile devices, cloud backend 150, and other enterprise systems such as (but not limited to) ERP, WMS, and/or quality management platforms. This may allow detected issues to be automatically reported to relevant personnel or integrated into existing workflows.

The physical environment where inspections occur may be a manufacturing facility, warehouse, or other industrial setting. Proper lighting conditions may be maintained to ensure captured images are of sufficient quality for AI analysis. The environment may include visual indicators or reference markers to assist in object detection and measurement.

### V. PLATFORM OPERATION

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Master Method

Consistent with embodiments of the present disclosure, a method may be performed by at least one of the aforementioned modules. The method may be embodied as, for example, but not limited to, computer instructions, which, when executed, perform the method.

A packing station monitoring system may be installed or otherwise provided at a packing station. The packing monitoring system may receive, from a user, an initiation of an application for controlling the content capture device. Thereafter, the system may receive content comprising an identifier associated with a carton to be packed. Responsive to receiving the content, the device may decode the identifier to retrieve metadata associated with the carton to be packed, and may initiate content capture for a time duration during which the carton can be packed according to a routing guide. Responsive to one or more of the time duration elapsing or receipt of a command to end recording, the system may stop content capture. Finally, the system may upload the captured content and at least a portion of the retrieved metadata to a data store.

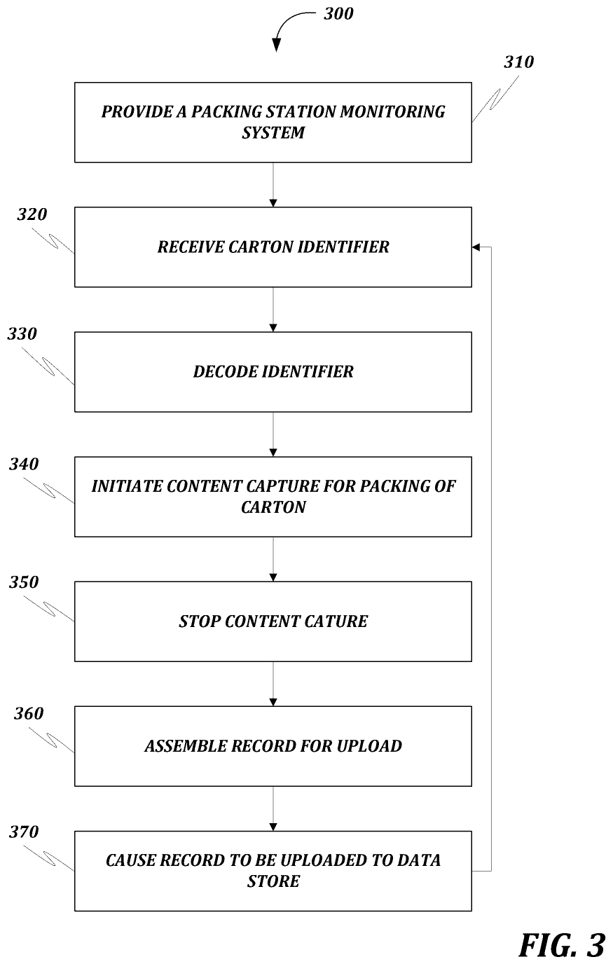

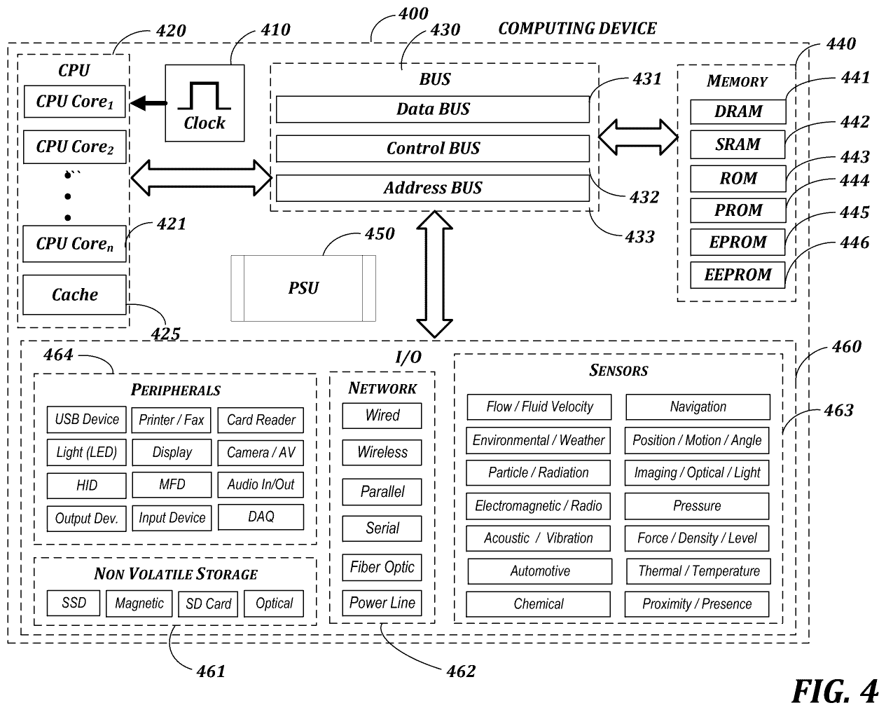

FIG. 3 is a flow chart setting forth the general stages involved in a method 300 consistent with an embodiment of the disclosure for providing packing station monitoring system or platform 100. Method 300 may be implemented using a computing device 400 or any other component associated with platform 100 as described in more detail below with respect to FIG. 4. For illustrative purposes alone, computing device 400 is described as one potential actor in the following stages.

Method 300 may begin at stage 310 where a packing station monitoring system may be provided at a packing station. For example, a support arm may be mounted in the vicinity of (e.g., above) a packing station. One or more tablet computing devices may be removably coupled to the support arm. The tablet computing device(s) may include a camera for use in capturing packing operations. In this way, the packing station monitoring system may be mounted to or in the vicinity of the packing station using the support arm. The packing station monitoring system may be mounted above the packing station, directly above the packer, so that it can capture video of everything that goes into the box or carton.

In some embodiments, providing the packing system monitoring station may include providing a content capture device and a computing device comprising monitoring software configured to control a content capture device. Optionally, the packing system monitoring station may further include software configured to limit or prevent access to one or more other applications.

Method 300 may include stage 320 where computing device 400 may receive content comprising an identifier associated with a carton to be packed. For example, the content capture controller may receive, from a content capture device, photo or video data corresponding to an identifier. The identifier may include a QR code, a barcode, a text-based label, or any other item configured to store or encode, in a human- and/or machine-readable format. The computing device may capture an image comprising at least a portion of the identifier. Additionally or alternatively, the identifier may be received via reading from a QR code scanner, barcode scanner, and/or the like.

In embodiments, the computing device 400 may begin receiving the content in response to a user initiation of content capture controlling software. The initiation may include, for example, tapping, clicking, or otherwise activating an icon associated with the software.

In some embodiments, a user may provide a user identifier (e.g., username, biometric signal, and/or the like) and/or a password to initiate execution of the software. This may allow the captured content to be directly associated with the particular user.

After computing device 400 receives the identifier in stage 320, method 300 may proceed to stage 330 where computing device may decode the identifier. Decoding the identifier may allow the computing device 400 to retrieve metadata associated with the carton to be packed. Decoding the identifier may include, for example, decoding data stored in a QR code, reading a barcode, and/or performing an optical character recognition process or at least a portion of a text-based label. In some embodiments, the identifier may directly store the information to be decoded. In other embodiments, the identifier may include a uniform resource identifier (URI) indicating a network-accessible location at which the data is stored. The computing device may decode the identifier to determine metadata such as (but not limited to) a carton identifier that identifies the particular carton or box to be packed, a sales order identifier indicating a sales order associated with the items to be packed in the carton, a purchase order identifier associated with a purchase order for the sale, and/or any other identifying data associated with the items included in an order for a particular recipient.

After computing device 400 decodes the identifier in stage 330, method 300 may proceed to stage 340 where computing device may Initiate content capture. In some embodiments, the computing device may initiate content capture for a time duration during which the carton can be packed according to a routing guide. For example, the computing device may initiate content capture to last for a fixed duration (e.g., 30 seconds, 60 seconds, etc.). The duration may be fixed, or may be variable based on, for example, the amount of product to be packed in the carton, the average packing speed of the packer at the packing station, a requirement set forth in a routing guide for the recipient, a requirement established by the warehouse, and/or any other factors that may be useful in determining a packing time. In some embodiments, the computing device may set an upper bound for the recording duration, but may receive, from a user, an indication that the packing is complete and recording should stop. In some embodiments, the computing device may provide an alert, such as an audible alert, indicating that the content capture process has begun.

During recording, the computing device 400 may display a visual countdown timer on a screen of the tablet computing device indicating remaining video capture time. The computing device 400 may generate an audible alert when a set amount (e.g., 10 seconds) of video capture time remains, alerting the user that packing time has nearly expired. In some embodiments, the user may be able to extend the video capture timing using one or more spoken and/or touch commands.

While the computing device 400 records content, a user may perform steps for packing a carton, including (but not limited to) one or more of:
Placing an empty carton/box at the packing station,
Packing the carton with one or more order items, as included in a sales order or purchase order,
Adding dunnage or filler to the carton, as needed to prevent the packed products from shifting excessively during transit,
Adding any paperwork to the carton, in compliance with a routing guide,
Sealing the carton (e.g., with tape or other fasteners), or
Placing the carton on a pallet or conveyor.

In some embodiments, the computing device may use artificial intelligence and/or computer vision systems to determine a number of different items placed in a carton, how many of each type of item were placed in the carton, and/or relative condition of packaging for each item placed in the carton.

In some embodiments, the system may further be used to capture content related to a pallet on which the cartons are placed. This may advantageously show that the individual cartons and/or the pallet itself were not damaged at the warehouse facility (e.g., during palletization of the cartons).

The method 300 may proceed to stage 350 where computing device 400 may stop content capture by the content capture device. For example, the content capture may be stopped in response to one or more of the time duration elapsing or receipt of a command to end recording. In some embodiments, the system may provide a notification, such as an audible alert, upon stopping the content capture.

In some embodiments, the computing device 400 may analyze the captured content using artificial intelligence (AI) techniques. For example, the computing device 400 may utilize computer vision and machine learning algorithms to detect and identify objects, measure dimensions, count items, perform optical character recognition (OCR), and identify anomalies or quality issues in the captured photos or videos.

The AI analysis may include, but not be limited to object detection to identify and count individual boxes, pallets, or other items in the image, measurement of pallet heights and/or package dimensions, optical character recognition (OCR) algorithms to read text from shipping labels, packing slips, or other documents, anomaly detection to identify missing components, improper packaging, and/or damage, quality assessment to detect blurry, dark, or otherwise unusable images, and/or any other AI analysis techniques useful in reviewing the captured content.

The AI models used for analysis may be pre-trained on relevant supply chain imagery and fine-tuned for the specific use cases of the packing station monitoring system. The models may run on the mobile device itself for real-time analysis, or the captured content may be sent to cloud-based AI services for more intensive processing.

After analyzing the content, the computing device 400 may generate alerts and/or notifications based on the AI analysis results. For example, if the AI detects a missing component or improper packaging, the computing device 400 may display an error message to the user and prevent them from proceeding until the issue is resolved. The system may send email or SMS alerts to supervisors or quality control personnel if certain predefined conditions are met. The alerts may include (but need not be limited to): on-screen notifications to the packing station user, email alerts to supervisors with details of detected issues, and/or integration with an existing warehouse management system to flag problematic orders.

Once content capture is ended, the method 300 may proceed to stage 360 where computing device 400 may assemble a record for upload to the data store. The record may be formed as MMS data record 500, using the structured format identified above. In some embodiments, including the captured content in the record may optionally include the computing device 400 encoding and/or re-encoding the content using an encoding algorithm configured to reduce an amount of memory taken up by the content in storage.

The assembled record may further include metadata associated with the content. As non-limiting examples, the metadata may include, but need not be limited to, at least a portion of the data retrieved from the decoded identifier (e.g., the carton identifier, the sales order identifier, and/or the purchase order identifier), a date stamp indicating a date the carton was packed, a time stamp indicating the time at which the carton was packed (e.g., a beginning time, an ending time, etc.), a date and/or time that the content is uploaded, an amount of time take to pack the carton, a geolocation at which the carton was packed (e.g., GPS coordinates associated with the packing station, a location of the warehouse, etc.), an employee identifier associated with the employee that packed the carton, a station identifier identifying the packing station used to pack the carton, a copy of the packing manifest and/or any other paperwork included in the carton, and/or any other information available to help describe the packing process.

In some embodiments, the computing device 400 may augment the captured content and metadata with the results of the AI analysis. This may include adding annotations to images to highlight detected objects or issues, appending AI-generated metadata such as item counts, measurements, and/or the like, and including any alerts or notifications generated.

The augmented record may comprise the original captured content (e.g., photos and/or videos), AI-annotated versions of the media highlighting detected objects/issues, metadata from the original capture (e.g., timestamp, user ID, location, etc.), AI-generated metadata (e.g., item counts, measurements, detected anomalies), and any alerts or notifications triggered by the AI analysis. This augmented record provides a comprehensive documentation of the packing process, combining human-captured imagery with AI-powered insights and annotations.

In stage 370, the computing device 400 may cause the assembled record to be uploaded to a data store. For example, the data store may be a database maintained at a cloud storage location, a dedicated server, a storage area network, a network addressable storage device, or any other data store accessible by the computing device.

In some embodiments, each record to be uploaded (including video content captured by the content capture device and metadata) may have a file size in a range of about 12 to 15 MB in size, on average. Upload of a file of this size may take on the order of about 10 seconds, depending on the type of network used to upload and network conditions, such bandwidth, throughput, loss, and the like. Accordingly, it may be desirable to implement a queuing process for the uploads, whereby the captured content and associated metadata are uploaded to the data store sequentially (e.g., one by one) in another thread or process using a batch model, rather than an interactive model.

Where an interactive record upload is performed, the computing device must wait until the upload is complete before moving to a next step. Alternatively, where a batch upload is performed, the upload occurs in another thread of the software or another application. Accordingly, the main thread that captured the video may “hand off” the record to the batch thread, so that the batch thread may perform the record upload process, while the main thread may move on to the next stage in the process, without waiting for the record upload to complete. The batch record upload process may have a smooth queuing process, that queues the records sequentially (e.g., one by one) and uploads the video and the metadata smoothly. The batch record upload process also allows for temporary pauses to the upload. For example, uploads may be paused if there is a disruption in the network signal or the data plan to help ensure that all records that are queued are uploaded to the data store without any missing data.

To implement the queueing process for managing sequential uploads in the packing station monitoring system, a queue data structure may be utilized to store and manage the packing records waiting to be uploaded. This queue may be implemented as a first-in-first-out (FIFO) structure, where records are added to the back of the queue and removed from the front for processing.

The queue may contain packing record objects, with each object comprising the captured video/images, associated metadata, and any other relevant information. These objects may be stored in memory and/or persisted to local storage on the device.

In some embodiments, objects may be uploaded in the order in which they are received in the queue. Alternatively, a prioritization logic may be applied to determine the order of uploads. This may involve factors such as (but not limited to) time of capture (e.g., older records may be prioritized), size of the record (e.g., smaller records may be uploaded first to maximize throughput, larger records may be uploaded first to free device space, etc.), network conditions (e.g., larger uploads may be deferred if network speed is slow), criticality of the data (e.g., certain types of records may be flagged as high priority), and/or the like.

An upload manager component may interact with the queue to process uploads. This manager may check for available network connectivity, retrieve the next record from the front of the queue, initiate the upload process for that record, and monitor upload progress. The manager component may be configured to handle any errors or retries, and to remove and successfully uploaded records from the queue.

The upload manager may run as a background process, continuously checking the queue and initiating uploads as network conditions allow. It may also implement throttling to avoid overloading the network or server.

A separate thread or process may handle adding new records to the queue as they are captured. This allows the capture process to continue uninterrupted even if uploads are temporarily paused.

The system may maintain persistent state information about the queue and in-progress uploads. This allows uploads to be resumed if the application is closed or the device restarts.

Status updates may be provided to the user interface to indicate upload progress. The system may also generate alerts if the queue size grows beyond a certain threshold, indicating potential upload delays.

By implementing this queuing architecture, the system can efficiently manage sequential uploads while providing flexibility to handle varying network conditions and prioritization needs.

Each packing record may be associated with corresponding shipping information in the data store. The computing device may receive captured content and metadata from the content capture device after a packing operation is completed, and may generate a unique packing record identifier for each packing operation. The packing record may be stored in a database table in the data store. A separate shipping information table may be maintained in the database. The carton identifier may be used as a key to link the packing records table and shipping information table. An indexing structure may be created on the carton identifier fields in both tables to optimize join queries.

When retrieving packing records, a query may be executed to join the two tables on the carton identifier, allowing shipping details to be associated with the corresponding packing record. Additional indexes may be created on frequently queried fields like timestamps, user IDs, or tracking numbers to further improve retrieval performance. The data store may implement a caching layer to keep frequently accessed packing records and shipping information in memory for faster access. An API layer may be provided to allow external systems to query and retrieve the associated packing and shipping data using defined endpoints.

This database schema and indexing approach may allow for efficient storage and retrieval of packing records with their corresponding shipping information. The exact implementation details may vary based on the specific database technology used in the data store.

Following the upload in stage 3600 (e.g., the interactive upload or the hand-off to the batch upload thread), the process may return to stage 320 where a new identifier for a new carton may be read, until all cartons have been processed.

In this way, the system can capture content showing the packing of each carton in an order, which may be easily accessed for verification that an order was correctly packed. The recipient may receive a link to the content associated with the order packing. The notification may be sent in response to the order being packed and/or in response to a query regarding the order from the recipient.

By optionally leveraging AI capabilities, the packing station monitoring system may provide enhanced documentation, real-time quality control, and actionable insights to improve supply chain operations. The integration of AI analysis with the existing photo/video capture workflow creates a powerful tool for ensuring accuracy, compliance, and efficiency in packing and shipping processes.

### VI. HARDWARE CONFIGURATION

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 400. The computing device 400 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;
Platform 100 may be hosted on a centralized server or a cloud computing service. Although method 300 has been described to be performed by a computing device 400, it should be understood that, in some embodiments, different operations may be performed by a plurality of the computing devices 400 in operative communication on at least one network.

Embodiments of the present disclosure may comprise a system having a central processing unit (CPU) 420, a bus 430, a memory unit 440, a power supply unit (PSU) 450, and one or more Input/Output (I/O) units. The CPU 420 coupled to the memory unit 440 and the plurality of I/O units 460 via the bus 430, all of which are powered by the PSU 450. It should be understood that, in some embodiments, each disclosed unit may actually be a plurality of such units for redundancy, high availability, and/or performance purposes. The combination of the presently disclosed units is configured to perform the stages of any method disclosed herein.

FIG. 4 is a block diagram of a system including computing device 400. Consistent with an embodiment of the disclosure, the aforementioned CPU 420, the bus 430, the memory unit 440, a PSU 450, and the plurality of I/O units 460 may be implemented in a computing device, such as computing device 400 of FIG. 4. Any suitable combination of hardware, software, or firmware may be used to implement the aforementioned units. For example, the CPU 420, the bus 430, and the memory unit 440 may be implemented with computing device 400 or any of other computing devices 400, in combination with computing device 400. The aforementioned system, device, and components are examples and other systems, devices, and components may comprise the aforementioned CPU 420, the bus 430, and the memory unit 440, consistent with embodiments of the disclosure.

At least one computing device 400 may be embodied as any of the computing elements illustrated in all of the attached figures. A computing device 400 does not need to be electronic, nor even have a CPU 420, nor bus 430, nor memory unit 440. The definition of the computing device 400 to a person having ordinary skill in the art is “A device that computes, especially a programmable [usually]electronic machine that performs high-speed mathematical or logical operations or that assembles, stores, correlates, or otherwise processes information.” Any device which processes information qualifies as a computing device 400, especially if the processing is purposeful.

With reference to FIG. 4, a system consistent with an embodiment of the disclosure may include a computing device, such as computing device 400. In some configurations, the computing device 400 may include at least one clock module 410, at least one CPU 420, at least one bus 430, and at least one memory unit 440, at least one PSU 450, and at least one I/O 460 module, wherein I/O module may be comprised of, but not limited to a non-volatile storage sub-module 461, a communication sub-module 462, a sensors sub-module 463, and a peripherals sub-module 464.

In a system consistent with an embodiment of the disclosure, the computing device 400 may include the clock module 410, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 420, the central component of modern computers, which relies on a clock signal. The clock 410 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 400 may use a “clock multiplier” which multiplies a lower frequency external clock to the appropriate clock rate of the CPU 420. This allows the CPU 420 to operate at a much higher frequency than the rest of the computing device 400, which affords performance gains in situations where the CPU 420 does not need to wait on an external factor (like memory 440 or input/output 460). Some embodiments of the clock 410 may include dynamic frequency change, where, the time between clock edges can vary widely from one edge to the next and back again.

In a system consistent with an embodiment of the disclosure, the computing device 400 may include the CPU 420 comprising at least one CPU Core 421. In other embodiments, the CPU 420 may include a plurality of identical CPU cores 421, such as, but not limited to, homogeneous multi-core systems. It is also possible for the plurality of CPU cores 421 to comprise different CPU cores 421, such as, but not limited to, heterogeneous multi-core systems, big.LITTLE systems and some AMD accelerated processing units (APU). The CPU 420 reads and executes program instructions which may be used across many application domains, for example, but not limited to, general purpose computing, embedded computing, network computing, digital signal processing (DSP), and graphics processing (GPU). The CPU 420 may run multiple instructions on separate CPU cores 421 simultaneously. The CPU 420 may be integrated into at least one of a single integrated circuit die, and multiple dies in a single chip package. The single integrated circuit die and/or the multiple dies in a single chip package may contain a plurality of other elements of the computing device 400, for example, but not limited to, the clock 410, the bus 430, the memory 440, and I/O 460.

The CPU 420 may contain cache 422 such as but not limited to a level 1 cache, a level 2 cache, a level 3 cache, or combinations thereof. The cache 422 may or may not be shared amongst a plurality of CPU cores 421. The cache 422 sharing may comprise at least one of message passing and inter-core communication methods used for the at least one CPU Core 421 to communicate with the cache 422. The inter-core communication methods may comprise, but not be limited to, bus, ring, two-dimensional mesh, and crossbar. The aforementioned CPU 420 may employ symmetric multiprocessing (SMP) design.

The one or more CPU cores 421 may comprise soft microprocessor cores on a single field programmable gate array (FPGA), such as semiconductor intellectual property cores (IP Core). The architectures of the one or more CPU cores 421 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 421, for example, but not limited to Instruction-level parallelism (ILP) such as, but not limited to, superscalar pipelining, and Thread-level parallelism (TLP).

Consistent with the embodiments of the present disclosure, the aforementioned computing device 400 may employ a communication system that transfers data between components inside the computing device 400, and/or the plurality of computing devices 400. The aforementioned communication system will be known to a person having ordinary skill in the art as a bus 430. The bus 430 may embody internal and/or external hardware and software components, for example, but not limited to a wire, an optical fiber, various communication protocols, and/or any physical arrangement that provides the same logical function as a parallel electrical bus. The bus 430 may comprise at least one of a parallel bus, wherein the parallel bus carries data words in parallel on multiple wires; and a serial bus, wherein the serial bus carries data in bit-wise serial form. The bus 430 may embody a plurality of topologies, for example, but not limited to, a multidrop/electrical parallel topology, a daisy chain topology, and connected by switched hubs, such as a USB bus. The bus 430 may comprise a plurality of embodiments, for example, but not limited to:
Internal data bus (data bus) 431/Memory bus
Control bus 432
Address bus 433
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu}Link]), Express Card, AdvancedTCA, AMC, Universal 10, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 400 may employ hardware integrated circuits that store information for immediate use in the computing device 400, known to persons having ordinary skill in the art as primary storage or memory 440. The memory 440 operates at high speed, distinguishing it from the non-volatile storage sub-module 461, which may be referred to as secondary or tertiary storage, which provides relatively slower-access to information but offers higher storage capacity. The data contained in memory 440, may be transferred to secondary storage via techniques such as, but not limited to, virtual memory and swap. The memory 440 may be associated with addressable semiconductor memory, such as integrated circuits consisting of silicon-based transistors, that may be used as primary storage or for other purposes in the computing device 400. The memory 440 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 441, Static Random-Access Memory (SRAM) 442, CPU Cache memory 425, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 443, Programmable ROM (PROM) 444, Erasable PROM (EPROM) 445, Electrically Erasable PROM (EEPROM) 446 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 400 may employ a communication system between an information processing system, such as the computing device 400, and the outside world, for example, but not limited to, human, environment, and another computing device 400. The aforementioned communication system may be known to a person having ordinary skill in the art as an Input/Output (I/O) module 460. The I/O module 460 regulates a plurality of inputs and outputs with regard to the computing device 400, wherein the inputs are a plurality of signals and data received by the computing device 400, and the outputs are the plurality of signals and data sent from the computing device 400. The I/O module 460 interfaces with a plurality of hardware, such as, but not limited to, non-volatile storage 461, communication devices 462, sensors 463, and peripherals 464. The plurality of hardware is used by at least one of, but not limited to, humans, the environment, and another computing device 400 to communicate with the present computing device 400. The I/O module 460 may comprise a plurality of forms, for example, but not limited to channel I/O, port mapped I/O, asynchronous I/O, and Direct Memory Access (DMA).

Consistent with the embodiments of the present disclosure, the aforementioned computing device 400 may employ a non-volatile storage sub-module 461, which may be referred to by a person having ordinary skill in the art as one of secondary storage, external memory, tertiary storage, off-line storage, and auxiliary storage. The non-volatile storage sub-module 461 may not be accessed directly by the CPU 420 without using an intermediate area in the memory 440. The non-volatile storage sub-module 461 may not lose data when power is removed and may be orders of magnitude less costly than storage used in memory 440. Further, the non-volatile storage sub-module 461 may have a slower speed and higher latency than in other areas of the computing device 400. The non-volatile storage sub-module 461 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 400 may employ a communication sub-module 462 as a subset of the I/O module 460, which may be referred to by a person having ordinary skill in the art as at least one of, but not limited to, a computer network, a data network, and a network. The network may allow computing devices 400 to exchange data using connections, which may also be known to a person having ordinary skill in the art as data links, which may include data links between network nodes. The nodes may comprise networked computer devices 400 that may be configured to originate, route, and/or terminate data. The nodes may be identified by network addresses and may include a plurality of hosts consistent with the embodiments of a computing device 400. Examples of computing devices that may include a communication sub-module 462 include, but are not limited to, personal computers, phones, servers, drones, and networking devices such as, but not limited to, hubs, switches, routers, modems, and firewalls.

Two nodes can be considered networked together when one computing device 400 can exchange information with the other computing device 400, regardless of any direct connection between the two computing devices 400. The communication sub-module 462 supports a plurality of applications and services, such as, but not limited to World Wide Web (WWW), digital video and audio, shared use of application and storage computing devices 400, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 462 may comprise a plurality of size, topology, traffic control mechanisms and organizational intent policies. The communication sub-module 462 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 400 may employ a sensors sub-module 463 as a subset of the I/O 460. The sensors sub-module 463 comprises at least one of the device, module, or subsystem whose purpose is to detect events or changes in its environment and send the information to the computing device 400. Sensors may be sensitive to the property they are configured to measure, may not be sensitive to any property not measured but be encountered in its application, and may not significantly influence the measured property. The sensors sub-module 463 may comprise a plurality of digital devices and analog devices, wherein if an analog device is used, an Analog to Digital (A-to-D) converter must be employed to interface the said device with the computing device 400. The sensors may be subject to a plurality of deviations that limit sensor accuracy. The sensors sub-module 463 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 400 may employ a peripherals sub-module 464 as a subset of the I/O 460. The peripheral sub-module 464 comprises ancillary devices uses to put information into and get information out of the computing device 400. There are 3 categories of devices comprising the peripheral sub-module 464, which exist based on their relationship with the computing device 400, input devices, output devices, and input/output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 400. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 464:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 400. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 400 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 400. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 462), data storage devices (non-volatile storage 461), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### VII. CLAIMS

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

The following is claimed:

1. A packing station monitoring system comprising:
a support arm configured to be mounted proximate to a packing station;
a content capture device coupled to the support arm, the content capture device comprising a camera;
a computing device in communication with the content capture device, the computing device comprising:
a processor;
a memory storing instructions that, when executed by the processor, cause the computing device to:
receive an identifier associated with a carton to be packed;
decode the identifier to retrieve metadata associated with the carton;
initiate content capture by the content capture device for a time duration;
stop content capture by the content capture device in response to at least one of: the time duration elapsing or receipt of a command to end recording; and
upload captured content and the metadata to a data store.

2. The system of claim 1, wherein the content capture device further comprises a code reader configured to read the identifier.

3. The system of claim 1, wherein the computing device comprises a tablet computer.

4. The system of claim 1, wherein the support arm comprises a light to illuminate an area below the support arm.

5. The system of claim 1, further comprising an audio device configured to provide audible alerts related to operation of the content capture device.

6. The system of claim 1, wherein the computing device further comprises a lockdown application configured to limit access to applications other than an application for controlling the content capture device.

7. The system of claim 1, wherein the data store is a cloud-based server configured to provide access to the captured content and metadata for verification of packing operations.

8. A packing station monitoring system comprising:
a support arm configured to be mounted proximate to a packing station;
a content capture device coupled to the support arm, the content capture device comprising a camera and a code reader;
a computing device in communication with the content capture device, the computing device comprising:
a processor;
a memory storing instructions that, when executed by the processor, cause the computing device to:
receive, via the code reader, an identifier associated with a carton to be packed;
decode the identifier to retrieve metadata associated with the carton;
initiate video capture by the camera for a predetermined time duration;
analyze the video capture in real-time using an artificial intelligence model to detect packing anomalies;
generate an alert if a packing anomaly is detected;
stop video capture in response to at least one of: the time duration elapsing or receipt of a stop command; and
upload the video capture and the metadata to a remote data store.

9. The system of claim 8, wherein the computing device and the content capture device are integrated into a single tablet computer device.

10. The system of claim 8, further comprising an audio device configured to provide audible alerts indicating start and stop of video capture.

11. The system of claim 8, wherein the support arm comprises an adjustable mount for positioning the content capture device.

12. The system of claim 8, wherein the computing device further comprises a lockdown application configured to restrict access to applications other than a packing monitoring application.

13. The system of claim 8, wherein the artificial intelligence model is configured to detect at least one of: missing items, incorrect items, improper packing technique, or inadequate protective packaging.

14. The system of claim 8, wherein the remote data store is a cloud-based server configured to provide secure access to the video capture and metadata for authorized users.

15. The system of claim 8, wherein the computing device is further configured to:
generate a packing record comprising the video capture, metadata, and any detected anomalies;
associate the packing record with shipping information for the carton; and
make the packing record accessible to recipients of the carton.

16. A method for monitoring packing operations at a packing station, the method comprising:
mounting a support arm above a packing station;
removably coupling a tablet computing device to the support arm, the tablet computing device comprising a camera;
receiving, via the camera, an image of a QR code affixed to a carton to be packed;
decoding the QR code to retrieve metadata comprising a carton identifier, a sales order number, and a purchase order number associated with the carton;
initiating video capture by the camera for a predetermined time duration;
stopping video capture upon expiration of the predetermined time duration;
assembling a packing record comprising the captured video and the retrieved metadata;
initiating upload of the packing record to a cloud-based data store; and
managing sequential upload of multiple packing records to the cloud-based data store using a queuing process.

17. The method of claim 16, further comprising:
restricting access on the tablet computing device to applications other than a packing monitoring application using a lockdown application.

18. The method of claim 16, further comprising:
adjusting a mount on the support arm to position the tablet computing device to capture video of an entire packing area.

19. The method of claim 16, further comprising:
analyzing the captured video in real-time using an artificial intelligence model to detect packing anomalies comprising at least one of: missing items, incorrect items, improper packing technique, or inadequate protective packaging; and
generating an alert displayed on the screen of the tablet computing device if a packing anomaly is detected.

20. The method of claim 16, further comprising:
associating each uploaded packing record with corresponding shipping information for the carton in the cloud-based data store;
providing secure access to packing records for authorized users based on user authentication; and
generating reports summarizing packing operations across multiple cartons.
